(19) United States
(12) Patent Application Publication
(10) Pub. No.: US 2010/0072232 A1
(43) Pub. Date: Mar. 25, 2010

(54) Apparatuses for Dispensing Liquids

(76) Inventor: Jeremy Rider, Bethesda, MD (US)

Correspondence Address: Byrne Poh LLP, 11 Broadway, Ste 865, New York, NY, 10004, US

(21) Appl. No.: 12/237,115

(22) Filed: Sep. 24, 2008

(51) Int. Cl. B67D 1/08; A45F 3/16

(52) U.S. Cl. 222/610; 224/414; 222/529

(57) ABSTRACT

Apparatuses for dispensing liquids are provided. In accordance with some embodiments, these apparatuses comprise: a bottle assembly having a value that allows liquid to pass from within the bottle assembly to outside of the bottle assembly; a cage for holding the bottle assembly that causes the valve to open when the bottle assembly is inserted into the cage and thereby allows liquid to flow from the bottle assembly into a portion of the cage; and a tube coupled to the portion of the cage that can be used by a user to draw liquid from the bottle assembly and the cage.

### TECHNICAL FIELD

The disclosed subject matter relates to apparatuses for dispensing liquids.

### BACKGROUND

It is well known that remaining hydrated while exercising is essential for comfort and safety. This is particularly true when riding a bicycle as dehydration can disorient a rider and cause the rider to loser control of the bicycle and become injured. Bottle and cage systems for bicycles are widely used to enable a rider to store liquid in a convenient location from which a bottle can be retrieved and used to pour liquid into the rider's mouth. When riding a bicycle, however, a rider's hands are dedicated to holding onto the handle bars so that the rider can control the direction of the bicycle and operate the brakes and gear shift (when the bicycle is so equipped). In order to facilitate near-hands-free drinking while riding a bicycle, many riders utilize a back-pack-style liquid container that has a tube connected to the container and located near the mouth of the rider. The rider can then insert the hose into the rider's mouth and drink. However, even such back-pack-style liquid containers require a rider to remove his/her hands from the handle bars of a bicycle while riding in order to insert the drinking tube into the rider's mouth.

Accordingly, new apparatuses for dispensing liquids are desirable.

### SUMMARY

Apparatuses for dispensing liquids are provided. In accordance with some embodiments, these apparatuses comprise: a bottle assembly having a valve that allows liquid to pass from within the bottle assembly to outside of the bottle assembly; a cage for holding the bottle assembly that causes the valve to open when the bottle assembly is inserted into the cage and thereby allows liquid to flow from the bottle assembly into a portion of the cage; and a tube coupled to the portion of the cage that can be used by a user to draw liquid from the bottle assembly and the cage.

### BRIEF DESCRIPTION OF THE DRAWINGS

FIG. 1 is a diagram of a bicycle with an installed apparatus for dispensing liquids in accordance with some embodiments.

FIG. 2 is a diagram of a bottle, cage, and tube in accordance with some embodiments.

FIG. 3 is a diagram of mounting holes on a cage in accordance with some embodiments.

FIG. 4 is an exploded-view diagram of a bottle and a cage in accordance with some embodiments.

FIG. 5 is a diagram showing a bottle being inserted into a cage in accordance with some embodiments.

FIG. 6 is a diagram of a bottle inserted into a cage and a piston on a bottle cap being depressed in accordance with some embodiments.

FIGS. 7A and 7B are diagrams of the bottom of a cage and a fitting that can be inserted into the cage in accordance with some embodiments.

FIG. 8 is a diagram of an arm for supporting a drinking tube that is mounted to the stem of a bicycle in accordance with some embodiments.

FIG. 9 is a diagram of an arm for supporting a drinking tube that is mounted to the handle bars of a bicycle in accordance with some embodiments.

FIG. 10 is a diagram of a drinking tube secured in a clip on an arm in accordance with some embodiments.

FIG. 11 is a diagram showing various angles at which an arm can be positioned in accordance with some embodiments.

FIG. 12 is an exploded-view diagram of a drinking tube and an arm in accordance with some embodiments.

### DETAILED DESCRIPTION

In accordance with various embodiments, as described in more detail below, apparatuses for dispensing liquids are provided. In some embodiments, these apparatuses can be used by bicycle to drink water, for example, while the riders' hands remain on the handle bars of their bicycles.

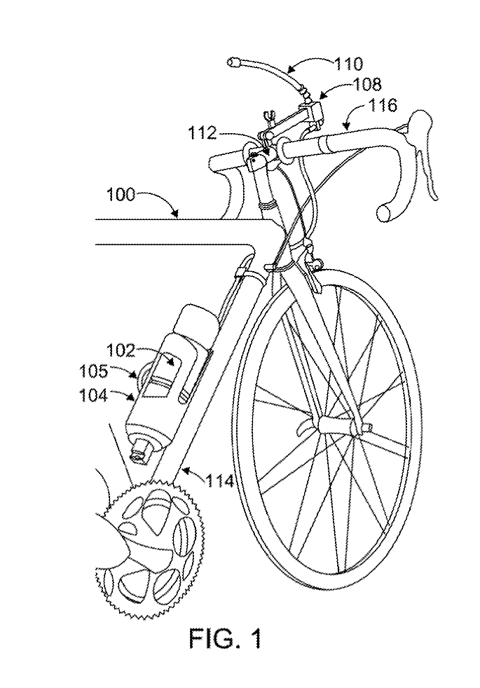

Turning to FIG. 1, an example of an apparatus in accordance with some embodiments is illustrated. As shown, a bottle assembly 102 for holding liquid is located in a bottle cage 104 that is mounted on a frame 114 of a bicycle 100. Liquid from bottle assembly, 102 can then pass out of the bottle through the cage and into a tube 105 connected to the bottom of the cage. This tube, and any liquid in it, runs up frame 114 toward the handle bars 116 of the bicycle. The handle-bar end of the tube is then connected to an arm 108 and a drinking tube 110. The arm is mounted to stem 112 holding handle bars 116 to the bicycle. In order to drink the liquid, the rider simply needs to position his/her head so that his/her mouth can draw liquid from drinking tube 110.

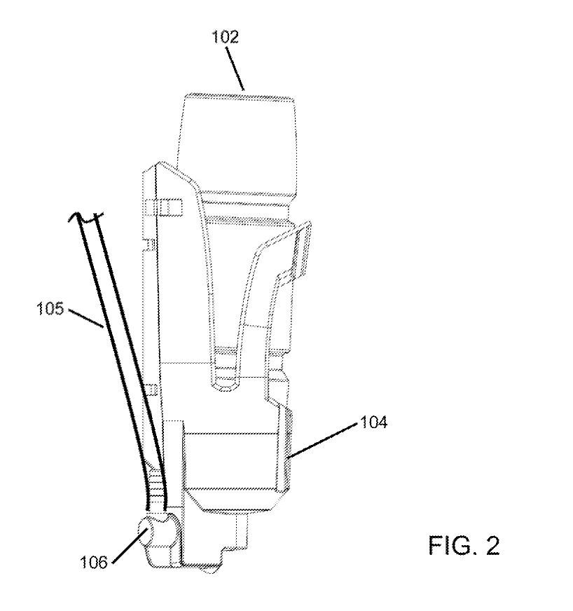

Further details of a bottle assembly 102 and cage 104 in accordance with some embodiments are illustrated in FIGS. 2-6, 7A, and 7B. As shown in FIG. 2, bottle assembly 102 can be positioned inside cage 104. At the bottom of cage 104, a fitting 106 can be provided for connecting a tube 105 to the bottom of the cage. As illustrated this fitting can be a barb fitting, although any suitable fitting for connection tube 105 to the cage can be used. The bottle, cage, fitting, and tube can be made of any suitable material or materials. For example, the bottle, cage, fittings, and tube can be made of food-safe plastics, rubbers, metals, and/or any other suitable materials.

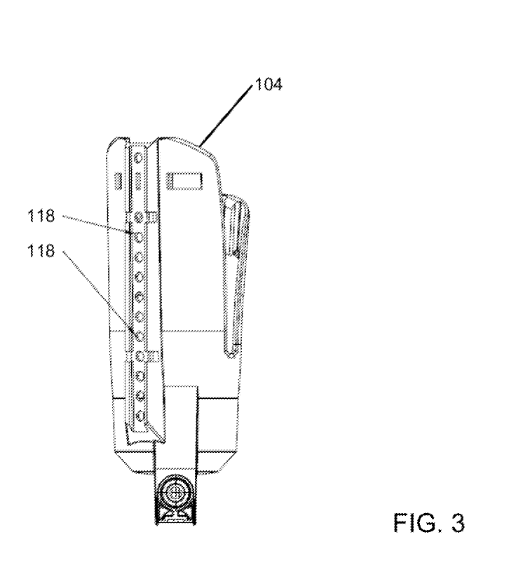

As shown in FIG. 3, mounting holes 118 can be provided in cage 104 to enable the cage to be mounted to the frame of a bicycle in accordance with some embodiments. Any suitable number of holes can be provided, and the holes can be spaced and sized so as to facilitate being aligned with standard bottle cage braze-ons. In some embodiments, alternate mounting mechanisms can additionally or alternatively be used to mount cage 104 to the frame of a bicycle. For example, the cage can be mounted to a frame using straps, such as tie-wraps or plastic ties.

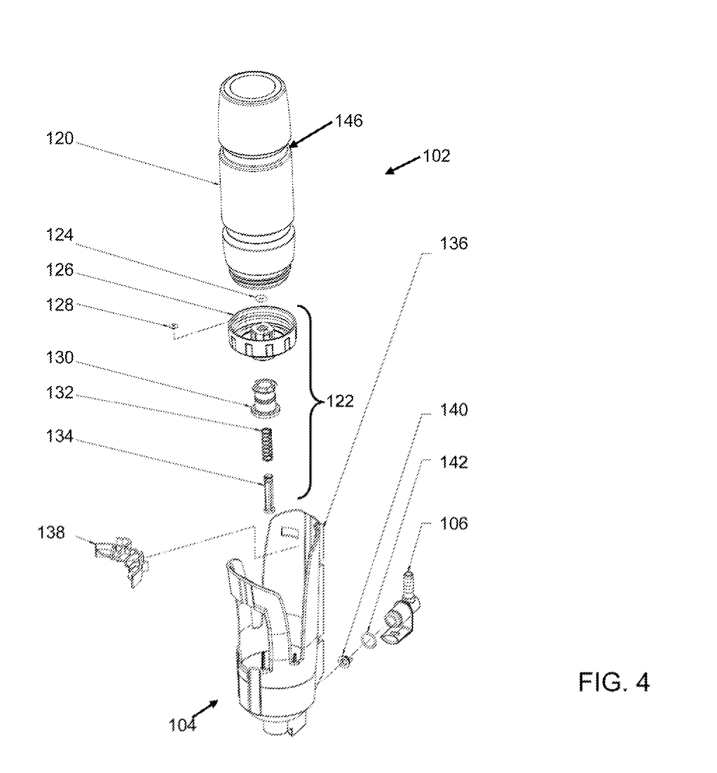

An exploded view of a bottle assembly 102 and cage 104 in accordance with some embodiments is shown in FIG. 4. As illustrated, bottle assembly 102 can be formed from a bottle body 120 and a bottle cap 122. Bottle body 120 can be any suitable shape and have any suitable mechanism (such as threads) for enabling its open-end to engage cap 122. As shown, the body can be sized to facilitate being held in one hand, and can have any suitable aesthetic design. Cap 122 can include a silicon o-ring 124, a lid 126, an umbrella valve 128, a bottle stopper 130, a piston spring 132, and a piston 134. These components can be assembled so that piston 134 goes through spring 132, stopper 130, and lid 126 and is held in place by o-ring 124. When piston 134 is depressed toward body 120 (such as is done by cage 104 as described below) liquid is able to pass out of the bottle body through the cap in the space surrounding the piston. In this way, piston 134 forms part of a valve in the bottle assembly. Additionally, in some embodiments, bottle stopper can be positioned to enable liquid to pass out of the bottle body when not in the cage by being pulled away from the bottle body, as is common in many sports bottle containers. Umbrella valve 128 can be used to allow air to enter the bottle assembly to replace the volume of liquid removed from the bottle body.

In some embodiments, cage 104 can include cage body 136, bottle retainer 138, duckbill valve 140, silicon o-ring 142, and fitting 106. Cage body 136 can be any suitable shape and dimension that facilitate bottle assembly 102 being securely held in the cage. Bottle retainer 138 can be used to hold bottle assembly 102 in cage 104 by interlocking with a groove 146 in bottle body 120. Duckbill valve 140 can be provided to limit the flow of liquid from the tube and fitting returning to the cage and bottle assembly. O-ring 142 can be used to provide a tight seal between fitting 106 and cage body 136.

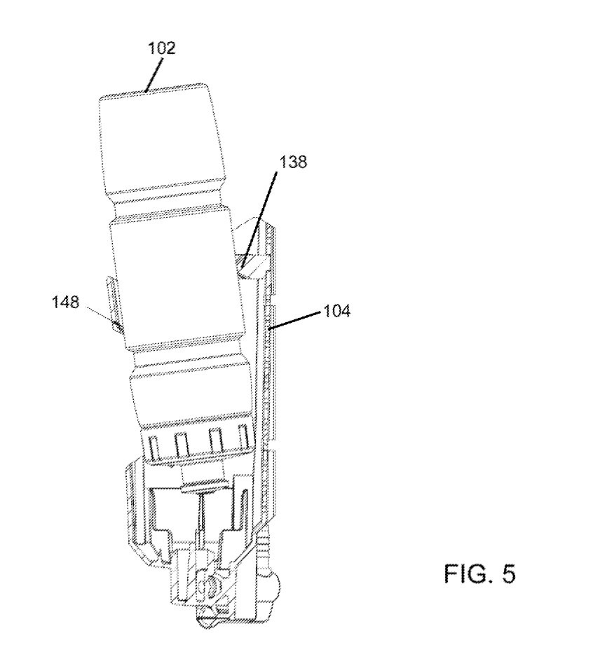

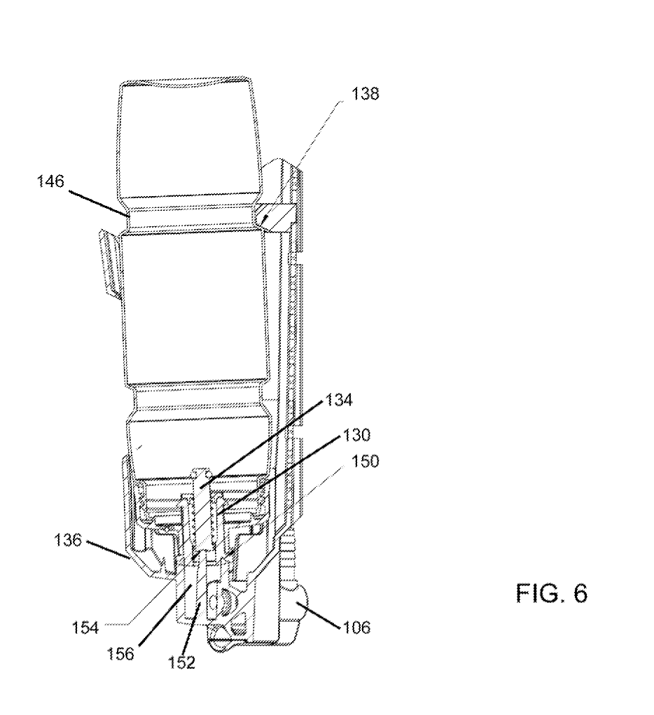

FIG. 5 illustrated bottle assembly 102 being inserted in cage 104 in accordance with some embodiments. As shown, when the bottle assembly is inserted in the cage, cage portion 148 may flex in order to allow sufficient dimensions for the bottle assembly to pass through the space between retainer 138 and portion 148. Once the bottle assembly is fully inserted into the cage, as shown in FIG. 6, piston 134 is depressed by member 152 at point 154 so that liquid can flow out of the bottle body through the cap. A seal 150 can be provided between cage body 136 and stopper 130 so that liquid flowing out of the bottle assembly remains in space 156 within cage 104 before passing through fitting 106.

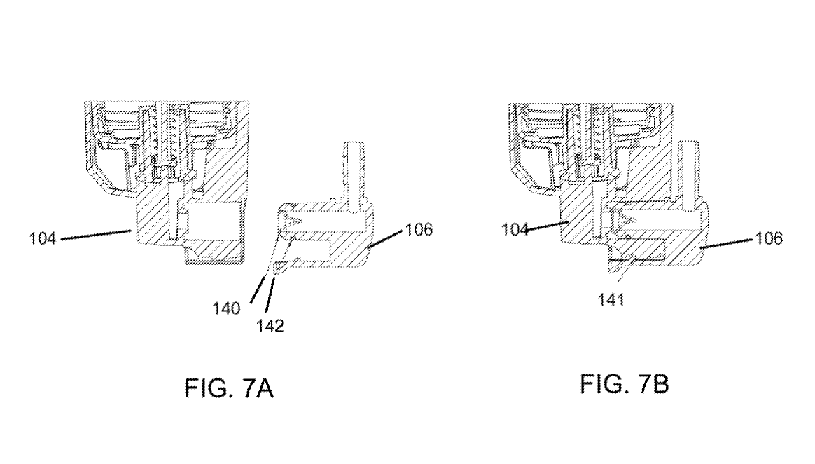

Further details of the bottom of cage 104 and fitting 106 in accordance with some embodiments are illustrated in FIGS. 7A and 7B. As shown in FIG. 7A, cage 104 and fitting 106 can be separated by removing the fitting from the cage. As also shown in FIG. 7A, duckbill valve 140 and o-ring 142 are assembled into fitting 106. As shown in FIG. 7B, fitting 106 can be inserted into the bottom of cage 104 by pressing the fitting into the corresponding hole in the cage. O-ring 142 seals the connection between cage 104 and fitting 106, and barb 141 holds fitting 106 in cage 104.

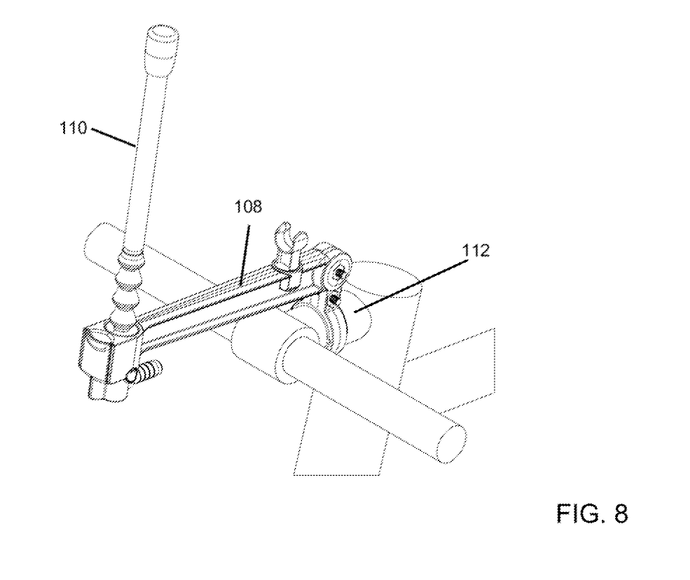

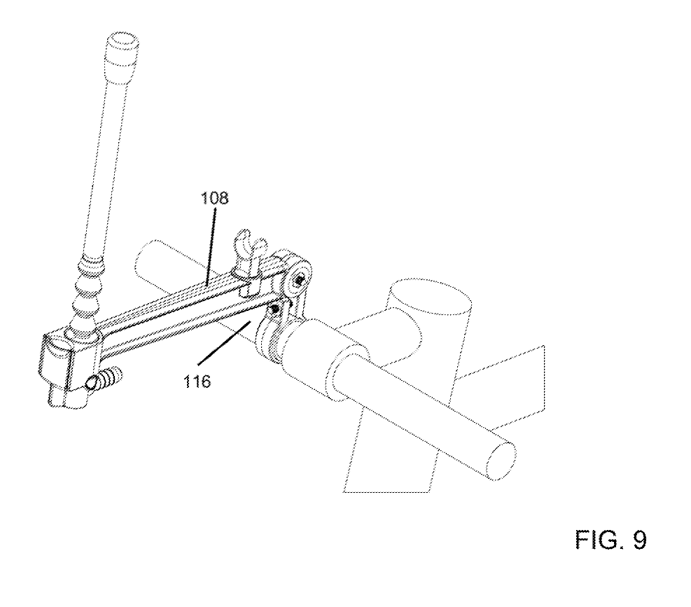

FIG. 8 illustrates further details of arm 108 and drinking tube 110 in accordance with some embodiments. The arm and drinking tube can be made of any suitable material or materials. For example, the arm and drinking tube can be made of food-safe plastics, rubbers, metals, and/or any other suitable materials. As shown, arm 108 can be connected to step 112 of a bicycle. Alternatively, as shown in FIG. 9, arm 108 can be configured in some embodiments so that it is connected to handle bars 116 of a bicycle. In some embodiments, arm 108 can be connected to any other suitable portion of a bicycle, or other device.

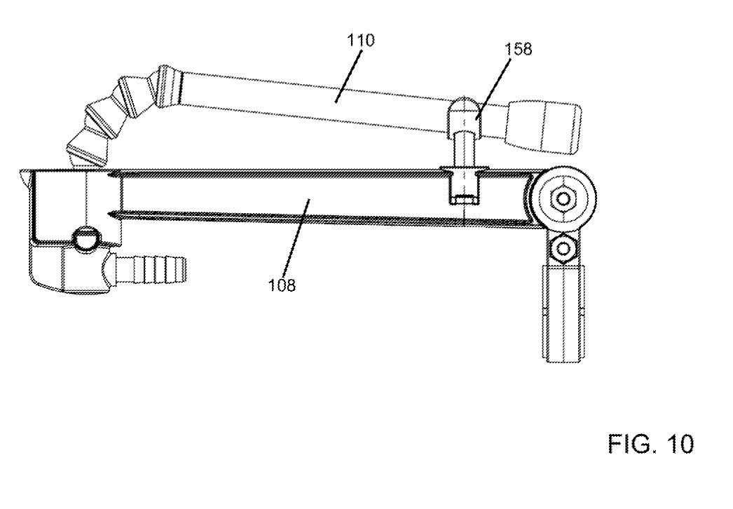

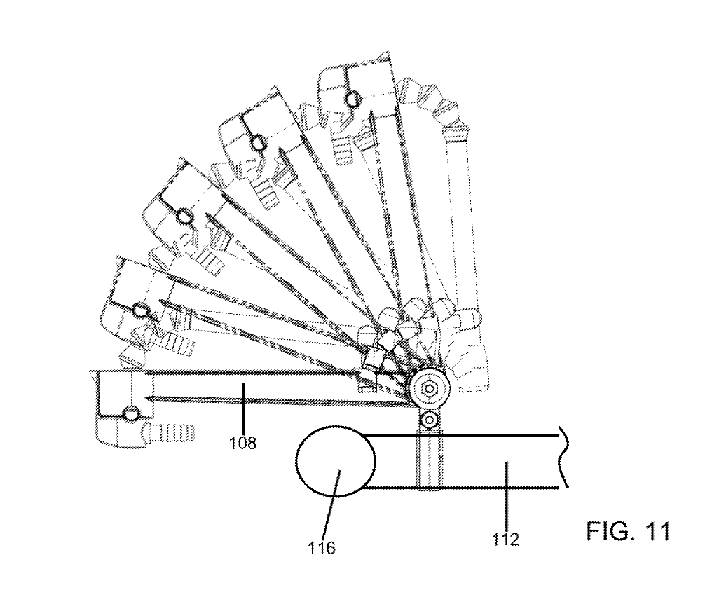

As shown in FIG. 10, in some embodiments, clip 158 can be provided on arm 108 to secure drinking tube 110 in a downward position. As shown in FIG. 11, in some embodiments, arm 108 can be rotated through different angles relative to stem 112 and handle bars 116 to facilitate riders with different location requirements for drinking tube 110. Any suitable range and/or increments of angles can be used.

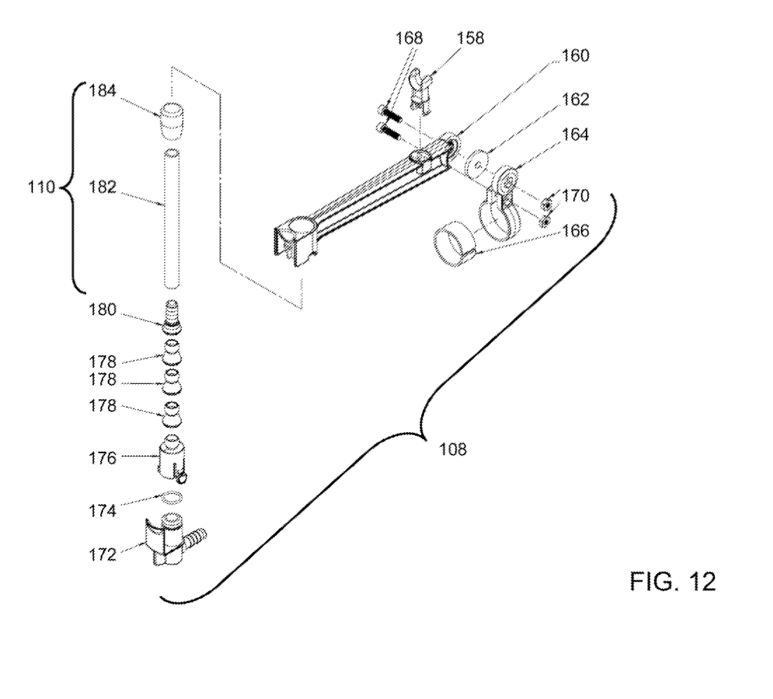

Further details of arm 108 and drinking tube 110 in accordance with some embodiments are illustrated in FIG. 12. As shown, arm 108 can include a clip 158 (as described above), an arm body 160, a washer 162, a bracket 164, a shim 166, screws 168, and nuts 170. Arm body 160 can be any suitable length and shape in order to facilitate positioning drinking tube 110 in a desired orientation. Washer 162 can be made from rubber in some embodiments in order to provide friction to hold arm in a desired orientation. Shim 166 can be used to couple bracket 164 to the stem or handle bars of a bicycle, and various size whims van be used to adapt the bracket to different sizes of stems and handle bars. Shim 166 can be formed from any suitable material, such as rubber. Screws 168 and nuts 170 can be any suitable screws and nuts for securing the arm and bracket.

At the opposite end of arm body 160, arm 108 can also include a fitting 172, a silicon o-ring 174, a fitting 176, loc-line links 178, a fitting 180, a tube 182, and a bite valve 184. Fitting 172 can be any suitable fitting (such as a barb fitting) for connecting to tube 105 (FIG. 1), and can be configured to engage arm body 160 and fitting 176 (which can be any suitable fitting) when snapped in place. O-ring 174 can be used to provide a tight seal between fittings 172 and 176. Loc-line links 178 can be provided to enable drinking tube 110 to be positioned at different orientations relative to arm 108. Although loc-line links are illustrated, any suitable mechanism for enabling a user to move the drinking tube can be used. Fitting 180 can then be used to couple tube 182 to loc-line links 178. Tube 182 can be any suitable type of tube, and can have any suitable dimensions. Finally, bite valve 184 van be connected to tube 182 and can provide a mechanism through which a rider can draw liquid from drinking tube 110 when the user bites on valve 184 and sucks liquid.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. For example, while these apparatuses have been described herein in connection with use on a bicycle, it will be apparent that these apparatuses can be used in any other suitable application, such as on exercise equipment, motorcycles and ATV's, personal water craft, etc. Features of the disclosed embodiments can be combined and rearranged in various ways.

What is claimed is:

1. An apparatus for dispensing liquids, comprising:
a bottle assembly having a valve that allows liquid to pass from within the bottle assembly to outside of the bottle assembly;
a cage for holding the bottle assembly that causes the valve to open when the bottle assembly is inserted into the cage and thereby allows liquid to flow from the bottle assembly into a portion of the cage; and
A tube coupled to the portion of the cage that can be used by a user to draw liquid from the bottle assembly and the cage.

2. The apparatus of claim 1, further comprising a drinking tube coupled to the tube that can be used to drink liquid and an arm that supports the drinking tube.

3. The apparatus of claim 2, further comprising a bite valve on the drinking tube.

4. The apparatus of claim 2, wherein the arm includes a clip for securing the drinking tube.

5. The apparatus of claim 2, wherein the drinking tube includes a mechanism that enables it to be repositioned relative to the arm

6. The apparatus of claim 5, wherein the mechanism is at least one loc-line link.

7. The apparatus of claim 2, wherein the arm includes a mechanism that enables it to be repositioned relative to a mounting location.

8. The apparatus of claim 1, further comprising a valve that limits the flow of fluid from the tube to the cage.

9. The apparatus of claim 1, wherein the valve is located in a cap of the bottle assembly.

10. The apparatus of claim 1, wherein the bottle assembly also includes an air valve for allowing air to enter the bottle assembly as liquid is drawn out of the bottle assembly.

11. The apparatus of claim 1, wherein the bottle assembly also includes a stopper that can allow liquid to be drawn out of the bottle when not inserted in the cage.

12. The apparatus of claim 1, wherein the cage includes a retainer for securing the bottle assembly in the cage.

13. The apparatus of claim 1, wherein the cage includes a seal that engages the bottle assembly when inserted into the cage.
